(19) United States
(12) Patent Application Publication
(10) Pub. No.: US 2003/0107013 A1
(43) Pub. Date: Jun. 12, 2003

(54) Variable valve with an electromagnetically-elongated actuator

(76) Inventors: Alfred Pappo, Melrose, MA (US); Mary E. Parent, Waltham, MA (US); Andrew Sumberg, Newton, MA (US); Anil Mavanur, Woburn, MA (US)

Correspondence Address: MIRICK, O'CONNELL, DEMALLIE & LOUGEE, LLP, 1700 WEST PARK DRIVE, WESTBOROUGH, MA, 01581-3941, US

(21) Appl. No.: 10/316,284

(22) Filed: Dec. 11, 2002

Related U.S. Application Data
(60) Provisional application No. 60/340,967, filed on Dec. 12, 2001.

(51) Int. Cl. F16K 31/02

(52) U.S. Cl. 251/11; 251/129.06; 251/129.01; 251/129.14

(57) ABSTRACT

A variable valve with an actuator that elongates upon application of an electrically-derived field. The valve includes an actuator comprising an actuator member made of a material that is elongated by an electrically-derived field. A coil surrounding the actuator member selectively applies an electrically-derived field to the actuator member. The valve further comprises a fluid flow path, an opening in the fluid flow path defining a flow area, and a closure member movable by the actuator member from a closed or more closed position in which it is restricting some or all of the flow area, to an open or more open position in which it is restricting less of the flow area, to selectively alter the fluid flow rate through the opening.

### CROSS REFERENCE TO RELATED APPLICATION

This application claims priority of Provisional application serial No. 60/340,967, filed on Dec. 12, 2001.

### FIELD OF THE INVENTION

This invention relates to a proportional valve with an electromagnetically-operated actuator. The valve is used to regulate the flow of a fluid in a variable manner.

### BACKGROUND OF THE INVENTION

Solenoid valves utilize a magnetic coil to generate a field that moves a ferrite material, in turn moving a ‘plug’ into and out of the path of the fluid, enabling flow. Although these valves are simple and low cost, they have two positions, on or off, and cannot be regulated to any other point between the two extremes. Proportional valves exist using combinations of two or more solenoids, but these valves are slow acting and involve an elaborate control system. Other proportional valves have complex, multi-part actuator/valve mechanisms that are expensive and prone to failure. Further, such valves do not work well at low temperatures, and are often bulky.

### SUMMARY OF THE INVENTION

It is therefore an object of this invention to provide a variable valve that is compact and can achieve high force.

It is a further object of this invention to provide such a valve that can achieve sub-micron positioning so that the mass flow rate though the valve can be very exactly controlled.

It is a further object of this invention to provide such a valve that is operated by an electrically-induced field, including a magnetic field and an electric field.

It is a further object of this invention to provide such a valve that can operate over a wide temperature range from cryogenic to room temperature and above.

This invention features a variable valve with an actuator that elongates upon application of an electrically-derived field, comprising an actuator comprising an actuator member comprising a material that is elongated by an electrically-derived field, and means for selectively applying an electrically-derived field to the actuator member. The valve further comprises a fluid flow path, an opening in the fluid flow path defining a flow area, and a closure member movable by the actuator member from a closed or more closed position in which it is restricting some or all of the flow area, to an open or more open position in which it is restricting less of the flow area, to selectively alter the fluid flow rate through the opening.

The material may be magnetically elongated. This can be accomplished with a magnetostrictive material or a magnet shape memory material. Alternatively, the material may be elongatable by the application of a voltage. This can be accomplished with a piezoelectric material or an electrostrictive material.

The actuator can position the closure member with sub-micron precision. The means for applying a field preferably comprises a coil. The coil may surround the actuator member. The fluid flow path may be, in part, outside of the coil. The actuator member may comprise an elongated rod. The actuator may further comprise a housing for the actuator member and electric coil. The actuator member may be mechanically coupled at one end to the housing. The fluid flow path may pass through the housing. The valve may further comprise a mechanical member directly between the rod and the closure member. The mechanical member may be at least in part located in the opening.

The opening may be defined in an orifice plate. The closure member may seat in the opening to fully close the opening in the closed position. The actuator member may be fixed at one location. The valve may further comprise a spring for placing a compressive force on the actuator member. The spring may act on the actuator member through the closure member, so that the spring also returns the closure member to its closed position. The spring may comprise a Belleville spring or a coil spring. The valve may further comprise a fluid seal between the actuator member and the fluid flow path. The fluid seal may be between the actuator member and the closure member. The actuator may lie at a right angle to the fluid flow path.

### BRIEF DESCRIPTION OF THE DRAWINGS

Other objects, features and advantages will occur to those skilled in the art from the following description of the preferred embodiments and the accompanying drawings in which:

FIG. 1 is a schematic, cross-sectional view of one embodiment of a variable valve according to this invention;

FIG. 2 is a similar view of an alternative preferred embodiment of the valve of this invention;

FIG. 3 is a similar view of yet another embodiment of the valve in this invention in which the actuator is not in the fluid flow path; and

FIG. 4 is a similar view of yet another embodiment in which the actuator is isolated from the fluid flow by a fluid seal.

### DETAILED DESCRIPTION OF THE PREFERRED EMBODIMENTS

This invention may be accomplished in a variable-flow valve with a valve actuator that is elongated upon the application of an electrically-derived field (a magnetic or electric field). The actuator can comprise a magnetic smart material (MSM) that exhibits reversible shape-changing characteristics induced by a magnetic field. One class of MSM's is magnetostrictive materials. Another class is magnetic shape memory materials that are alloys of Nickel, Manganese and Gallium. With such materials, the actuator elongation has a linear relation with respect to the strength of the applied field, and the elongation is repeatable. These features allow for a very simple controller. The materials also exhibit relatively high strain and a relatively large force output compared to the actuator size. Sub-micron valve positioning is achievable, providing for very fine control over the mass flow rate regulated by the valve. MSM's also exhibit elongation over a wide temperature range from 0 to 350° K. The valves using these materials thus can be used across a wide spectrum of process and environmental conditions. Actuator materials useful in this invention that elongate upon application of an electric field (a voltage applied across the element) include piezoelectric and electrostrictive materials.

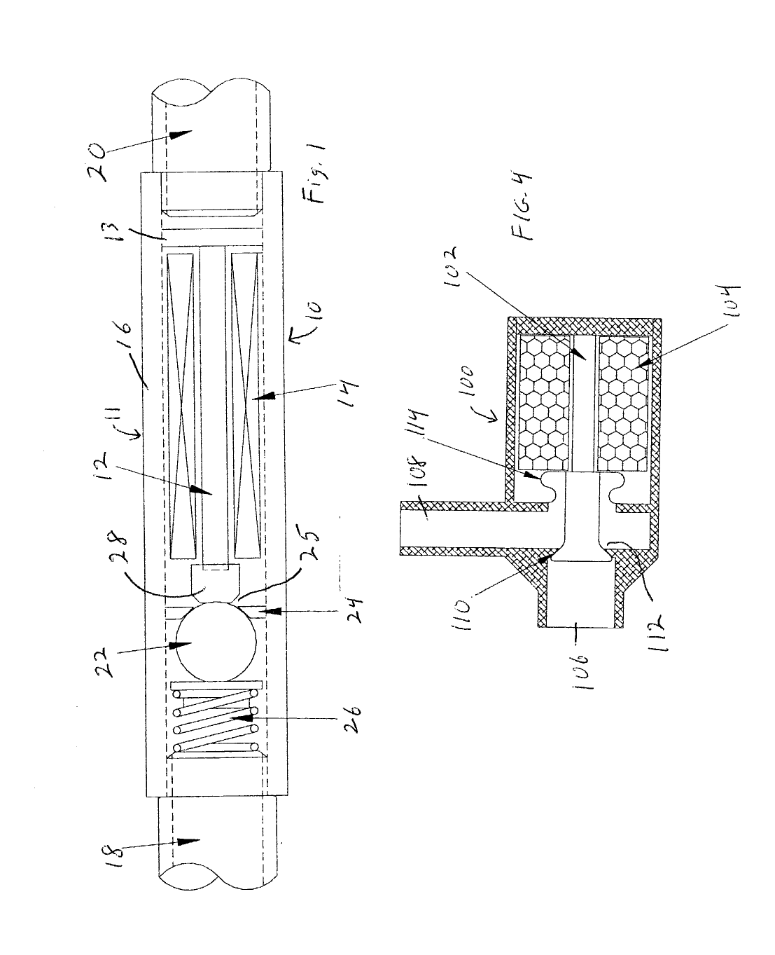

There is shown in FIG. 1 valve 10 according to this invention. Valve 10 includes actuator member 11 that comprises rod 12 of magnetic smart material that is elongated by a magnetic field that is controllably produced by coil 14 that surrounds rod 12 and comprises a means for selectively applying an electrically-induced magnetic field to actuator member 12. Actuator member 12 is fixed to fixed member 13, which itself is attached to housing 16. The other end of member 12 has mechanical member 28 coupled to its free end. Member 28 seats against valve closure member 22 which in this case is a ball that sits in opening 25 in orifice plate 24. Spring 26 has two functions. It urges closure member 22 into opening 25 and it also applies a pre-load force on actuator member 12. Some of the materials useful in the actuator member of this invention have higher strains at various pre-load forces. The fluid flow is co-axial with the actuator between fluid inlet 18 and fluid outlet 20.

Valve 10 is designed such that at zero applied electromagnetic field, ball 22 is seated in orifice plate 24 to fully close the valve. Upon the controlled application of current to coil 14, a controlled magnetic field is applied to actuator member 12, causing member 12 to elongate, which pushes mechanical member 28 against closure member 22 and spring 26, thereby controllably opening orifice 25 a desired amount. Since sub-micron elongations can be repeatedly and reversibly accomplished with magnetic smart materials, valve 10 can very exactly control the mass flow rate of a liquid or gas through the valve.

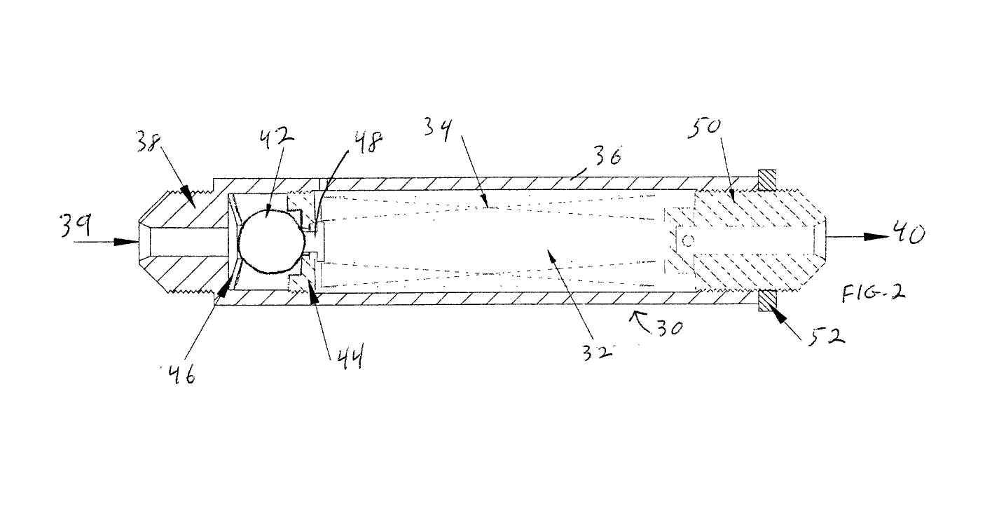

The remaining figures show several alternative embodiments of the variable valve of this invention. FIG. 2 depicts valve 30 which is also designed to be in-line with the inlet 39 and outlet 40. The primary differences between FIG. 2 and FIG. 1 are the use of threaded end plug 50 that is received by lock nut 52 that allows for variation in the pre-load force applied to MSM actuator 32. Also, this embodiment employs a Belleville spring 46 rather than a coil spring, and shows a different design for orifice-defining plate 44 in which ball valve closure member 42 sits. As with the embodiment of FIG. 1, the fluid flows around the outside of coil 34, between coil 34 and housing 36. Outer body 38 can be threaded so that the valve can be received in an opening in a fluid flow path.

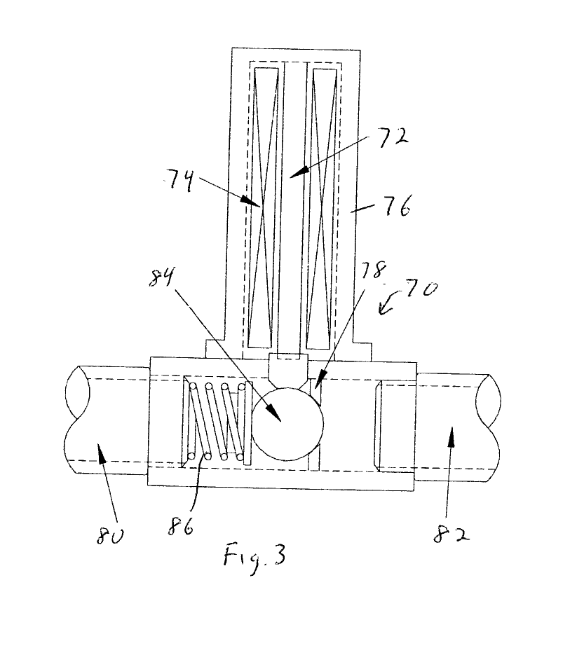

FIG. 3 depicts an embodiment similar to that of FIG. 1 but where the valve is at right angles to the fluid flow between inlet 80 and outlet 82. In this case, actuator member 72 moves closure member 84 from its engagement with orifice plate 78 upon the application of a magnetic field through coil 74. Spring 86 has the same function as spring 26, FIG. 1.

There also may be instances in which it is necessary or desirable to isolate the actuator from the fluid. This can be accomplished by the embodiment of FIG. 4 in which flexible fluid seal 114 lies between actuator member 102 and coil 104, and fluid flow path between inlet 106 and outlet 108. Closure member 110 seats in opening 112.

Although specific features of the invention are shown in some drawings and not others, this is for convenience only as the features may be combined in various fashions as would be apparent to these skilled in the art in accordance with the invention.

Other embodiments will occur to those skilled in the art and are within the following claims.

What is claimed is:

1. A variable valve with an actuator that elongates upon application of an electrically-derived field, comprising:
an actuator comprising:
an actuator member comprising a material that is elongated by an electrically-derived field; and
means for selectively applying an electrically-derived field to the actuator member;
a fluid flow path;
an opening in the fluid flow path defining a flow area;
a closure member movable by the actuator member from a closed or more closed position in which it is restricting some or all of the flow area, to an open or more open position in which it is restricting less of the flow area, to selectively alter the fluid flow rate through the opening.

2. The valve of claim 1 wherein the material is magnetically elongated.

3. The valve of claim 2 wherein the material comprises a magnetostrictive material.

4. The valve of claim 1 wherein the material is elongatable by the application of a voltage.

5. The valve of claim 4 wherein the material comprises a piezoelectric material.

6. The valve of claim 1 wherein the actuator can position the closure member with sub-micron precision.

7. The valve of claim 1 wherein the means for applying a field comprises a coil.

8. The valve of claim 7 wherein the coil surrounds the actuator member.

9. The valve of claim 8 wherein the fluid flow path is, in part, outside of the coil.

10. The valve of claim 7 wherein the actuator member comprises an elongated rod.

11. The valve of claim 10 wherein the actuator further comprises a housing for the actuator member and electric coil.

12. The valve of claim 11 wherein the actuator member is mechanically coupled at one end to the housing.

13. The valve of claim 11 wherein the fluid flow path passes through the housing.

14. The valve of claim 10 further comprising a mechanical member directly between the rod and the closure member.

15. The valve of claim 14 wherein the mechanical member is at least in part located in the opening.

16. The valve of claim 1 wherein the opening is defined in an orifice plate.

17. The valve of claim 16 wherein the closure member seats in the opening to fully close the opening in the closed position.

18. The valve of claim 1 wherein the actuator member is fixed at one location.

19. The valve of claim 1 further comprising a spring for placing a compressive force on the actuator member.

20. The valve of claim 19 wherein the spring acts on the actuator member through the closure member, so that the spring also returns the closure member to its closed position.

21. The valve of claim 19 wherein the spring comprises a Belleville spring.

22. The valve of claim 1 further comprising a fluid seal between the actuator member and the fluid flow path.

23. The valve of claim 22 wherein the fluid seal is between the actuator member and the closure member.

24. The valve of claim 1 wherein the actuator lies at a right angle to the fluid flow path.

25. The valve of claim 2 wherein the material comprises a magnet shape memory material.

26. The valve of claim 4 wherein the material comprises an electrostrictive material.

27. A variable valve with an actuator that elongates upon application of a magnetic field, comprising:
an actuator comprising:
an actuator member comprising a magnetostrictive material; and
a coil surrounding the actuator member for selectively applying an electrically-induced magnetic field to the actuator member;
a fluid flow path;
an opening in the fluid flow path defining a flow area;
a closure member movable by the actuator member from a closed or more closed position in which it is restricting some or all of the flow area, to an open or more open position in which it is restricting less of the flow area, to selectively alter the fluid flow rate through the opening.
